(19) United States
(12) Patent Application Publication
(10) Pub. No.: US 2014/0123666 A1
(43) Pub. Date: May 8, 2014

(54) System to Improve Gas Turbine Output and Hot Gas Path Component Life Utilizing Humid Air for Nozzle Over Cooling

(71) Applicant: GENERAL ELECTRIC COMPANY, Schenectady, NY (US)

(72) Inventors: Sanji Ekanayake, Mableton, GA (US); Alston Ilford Scipio, Mableton, GA (US); William Theadore Fisher, Roswell, GA (US); Stephen Paul Wassynger, Simpsonville, SC (US); Timothy Tah-teh Yang, Greenville, SC (US)

(73) Assignee: GENERAL ELECTRIC COMPANY, Schenectady, NY (US)

(21) Appl. No.: 13/751,675

(22) Filed: Jan. 28, 2013

Related U.S. Application Data
(63) Continuation-in-part of application No. 13/670,504, filed on Nov. 7, 2012.

(51) Int. Cl. F02C 3/30

(52) U.S. Cl. CPC F02C 3/30
USPC 60/775; 60/783; 60/39.182

(57) ABSTRACT

A system to improve gas turbine output and extend the life of hot gas path components includes a subsystem for estimating an amount of water or steam to be added to the flow of air to achieve the desired hot gas path temperature. The system includes a water or steam injection component adapted to inject the amount of water or steam to the flow of air to generate a flow of humid air and an injection subsystem adapted to inject the flow of humid air into a nozzle at the turbine stage are also included. The system includes a temperature sensor disposed at a turbine stage, and a subsystem for determining a desired hot gas path temperature at the turbine stage. An extraction conduit is coupled to a compressor stage and is adapted to extract a flow of air.

### CROSS REFERENCE TO RELATED APPLICATIONS

This application is a continuation-in-part of U.S. patent application Ser. No. 13/670,504, entitled “SYSTEMS AND METHODS FOR ACTIVE COMPONENT LIFE MANAGEMENT FOR GAS TURBINE ENGINES”, filed Nov. 7, 2012, which is herein incorporated by reference.

### TECHNICAL FIELD

The subject matter disclosed herein generally relates to gas turbine engines and more particularly to active component life management systems and methods to provide additional cooling to compensate for peak, low, and ultra-low load operations and other types of operational parameters.

### BACKGROUND

Gas turbine engine hot gas path parts life has a significant impact on the overall life-cycle economics of simple-cycle and combined-cycle power plants. Gas turbine engines generally use bleed air from one or more stages of a compressor to provide cooling and/or sealing of the components along the hot gas path within the turbine. Air may be extracted from the compressor and routed externally or internally to the locations that require cooling in the turbine, defined herein as a turbine cooling circuit. Any air compressed in the compressor and not used in generating combustion gases, however, generally reduces the overall efficiency of the gas turbine engine. Conversely, increased temperatures in the turbine may have an impact on emission levels and the lifetime of the components positioned along the hot gas path and elsewhere. Generally described, operations above base load will reduce the lifetime of the hot gas path components while operations below base load generally will extend component lifetime.

An exception to this relationship, however, may be found with respect to the nozzles and buckets of the stages aft of the first turbine stage. These aft stage inlet gas temperatures may be higher at peak fire than at base load and higher still at extended turndown or very low loads and firing temperatures. Gas turbine engines typically are designed for continuous base load operations with minimized cooling flows to the stages in order to maximize thermal efficiency. Given such, low load operations may be detrimental to the components in the aft stages while peak load operations may be detrimental to the components in all of the stages of the turbine.

The physics based understanding of gas turbine engine hot gas path parts life substantiates that operation above rated nominal firing temperature (T-fire) reduces hot gas path parts life and operation below rated nominal T-fire extends parts life. This relationship is quantified as the applicable Maintenance Factor (MF). The impact on the last stage nozzle and last stage bucket however is more complicated and has a relationship to T-fire and output such that the gas temperature at that stage takes a bathtub shape in relation to output and T-fire. The last stage gas temperature is higher at peak fire than at base-load and higher still at extended turndown or very low load and T-fire. This phenomenon imposes a counter-intuitive impact on the last stage components where operation at extended turndown level or ultra-low load poses the greatest negative parts life impact.

Gas turbine engines are typically designed for continuous base-load operation and as such make every effort to minimize cooling flows in order to maximize gas turbine engine thermal efficiency. However, this typical strategy can be detrimental under peak-load operation and ultra-low load operation. For gas turbine engines that are controlled to an exhaust temperature control schedule (legacy controls) or to a modified exhaust temperature control schedule, an externally variable turbine section cooling flow imposes an additional challenge to exhaust temperature controls where the measured exhaust temperature must be compensated to account for the effect of the variable cooling flow.

Conventional hot gas path temperature management systems do not provide sufficient means to manage the negative parts life impact of operation during peak and extended turndown (or ultra-low load operation). Additionally conventional hot gas path temperature management systems provide insufficient selective over-cooling of the hot gas path components to augment turbine peak load beyond nominal capability.

### BRIEF DESCRIPTION OF THE INVENTION

In accordance with one exemplary non-limiting embodiment, the invention relates to a method for operating a gas turbine engine. The method includes the steps of determining a hot gas path temperature at a turbine stage, and determining a desired hot gas path temperature at the turbine stage. A flow of air is extracted from a compressor stage, and an amount of fluid to be added to the flow of air to achieve a desired hot gas path temperature at the turbine stage is estimated. The method includes the step of adding the estimated amount of fluid to the flow of air to generate a flow of humid air, and injecting the flow of humid air into a nozzle at the turbine stage.

In another embodiment, a system for extending the life of hot gas path components is disclosed. The system includes a temperature sensor disposed at a turbine stage, and a subsystem for determining a desired hot gas path temperature at the turbine stage. An extraction conduit is coupled to a compressor stage and is adapted to extract a flow of air. The system includes a subsystem for estimating an amount of water or steam to be added to the flow of air to achieve the desired hot gas path temperature. A water or steam injection component adapted to inject the amount of water or steam to the flow of air to generate a flow of humid air and an injection subsystem adapted to inject the flow of humid air into a nozzle at the turbine stage are also included.

In another embodiment, a gas turbine engine having a compressor, a turbine, and a conduit coupled to a stage of the compressor adapted to extract a flow of air is disclosed. The gas turbine engine also includes a temperature sensor adapted to measure a hot gas path temperature at a stage of the turbine. The gas turbine engine also includes a water or steam injection chamber coupled to the conduit and adapted to inject a predetermined amount of water or steam to the flow of air to generate a flow of humid air, and an injector coupled to the conduit and adapted to inject the flow of humid air into the stage of the turbine.

In another embodiment a method for improving an output of a gas turbine having a compressor and a turbine is disclosed. The method includes the steps of determining a current output and a desired output. The method also includes the steps of extracting a flow of air from a compressor stage and estimating an estimated amount of fluid to be added to the flow of air to achieve the desired output. In an additional step, the method includes adding a fluid in an amount substantially equal to the estimated amount of fluid to the flow of air to generate a flow of humid air. The method also includes injecting the flow of humid air into a nozzle at a turbine stage, and adjusting the current output to the desired output.

Other features and advantages of the present invention will be apparent from the following more detailed description of the preferred embodiment, taken in conjunction with the accompanying drawings which illustrate, by way of example, the principles of certain aspects of the invention.

### BRIEF DESCRIPTION OF THE DRAWINGS

FIG. 1 is a schematic diagram of a gas turbine engine showing a compressor, combustor, a turbine, and a load.

FIG. 2 is a schematic diagram of an embodiment of a humid air cooling system as may be described herein.

FIG. 3 is a functional schematic of an embodiment of a control system used in a humid air cooling system.

FIG. 4 is a schematic diagram of a portion of a turbine with an infrared camera.

FIG. 5 is a flow chart of an embodiment of a method for operating a gas turbine engine using a humid air cooling system.

FIG. 6 is a flow chart of an embodiment of a method for improving an output of a gas turbine.

### DETAILED DESCRIPTION OF THE INVENTION

The systems and methods described herein provide for over-cooling the hot gas path nozzles with humid air coupled with exhaust temperature control compensation. In another embodiment direct hot gas path component metal temperature measurement with an optical transducer (e.g. infrared camera) is provided. In yet another embodiment direct hot gas path gas stream temperature measurement with an optical transducer (e.g. infrared camera) may be used. The cooling stream temperatures is measured and the cooling stream temperatures are controlled to the desired level with the addition of demineralized water or steam to increase cooling air “humidity” and mass flow. The over-cooling of all nozzle stages in the turbine will enable active parts life management which can be used to extend machine operation beyond its current boundaries within the context of additional authority for peak over-firing.

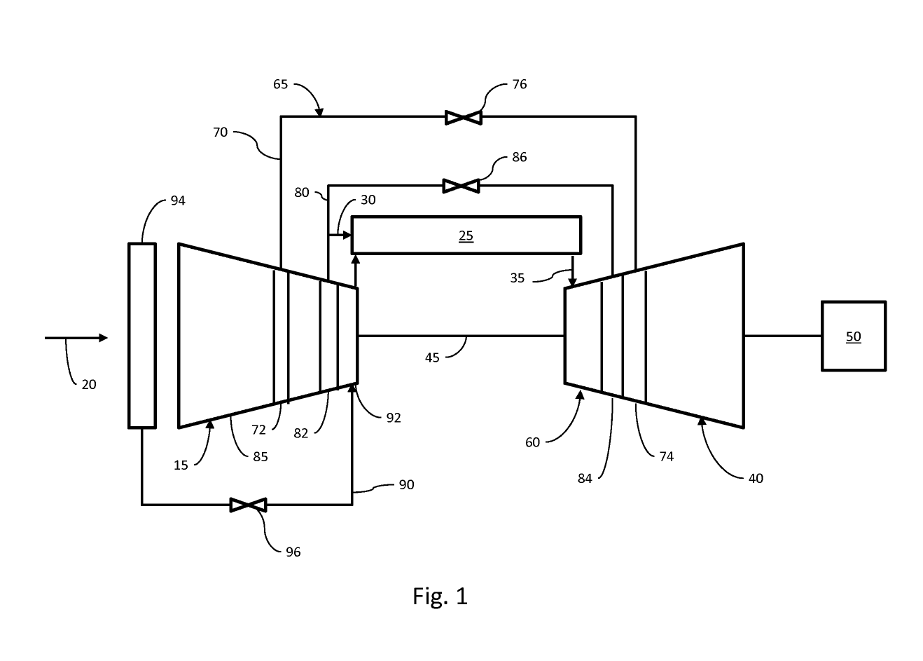

Referring now to the drawings, in which like numerals refer to like elements throughout the several views, FIG. 1 shows a schematic view of gas turbine engine 10 as may be used herein. The gas turbine engine 10 may include a compressor 15. The compressor 15 compresses an incoming flow of air 20. The compressor 15 delivers the compressed flow of air 20 to a combustor 25. The combustor 25 mixes the compressed flow of air 20 with a pressurized flow of fuel 30 and ignites the mixture to create a flow of combustion gases 35. Although only one combustor 25 is shown, the gas turbine engine 10 may include any number of combustors. The flow of combustion gases 35 is in turn delivered to a turbine 40. The flow of combustion gases 35 drives the turbine 40 so as to produce mechanical work. The mechanical work produced in the turbine 40 drives the compressor 15 via a shaft 45 and an external load 50 such as an electrical generator and the like.

The gas turbine engine 10 may use natural gas, liquid fuels, various types of syngas, and/or other types of fuels. The gas turbine engine 10 may be any one of a number of different gas turbine engines offered by various manufacturers globally. The gas turbine engine 10 may have different configurations and may use other types of components. More than one gas turbine engine 10, other types of turbo-machinery, and other types of power generation equipment also may be used herein together.

As described above, the compressor 15 may include a number of compressor stages 55 therein. Likewise, the turbine 40 also may have any number of turbine stages 60 therein. The gas turbine engine 10 thus may use a number of air extractions 65 to provide cooling air from the compressor 15 to the turbine 40. In this example air is extracted from a first compressor stage 72 to a first turbine stage 74 using a first extraction conduit 70. As used herein, “first” and “second” are used to distinguish the stages one from the other, and not necessarily to imply the stage of the compressor 15 or turbine 40. For example, the first compressor stage 72 may refer to stage nine of the compressor 15, and the second compressor stage may refer to stage thirteen of the compressor 15. A first extraction control valve 76 may be positioned on the first extraction conduit 70. Likewise, the gas turbine engine 10 may have a second extraction conduit 80 extending from a second compressor stage 82 to a second turbine stage 84. A second extraction control valve 86 may be positioned on the second extraction conduit 80. A compressor discharge extraction conduit 90 may extend from a compressor discharge 92 to an inlet bleed heat manifold 94 or other location. The inlet bleed heat manifold 94 may be positioned about an inlet of the compressor 15. An inlet bleed heat manifold valve 96 may be used to control flow thereto. The extraction conduits may be internal or external to the turbine casing. Other components and other configurations may be used herein.

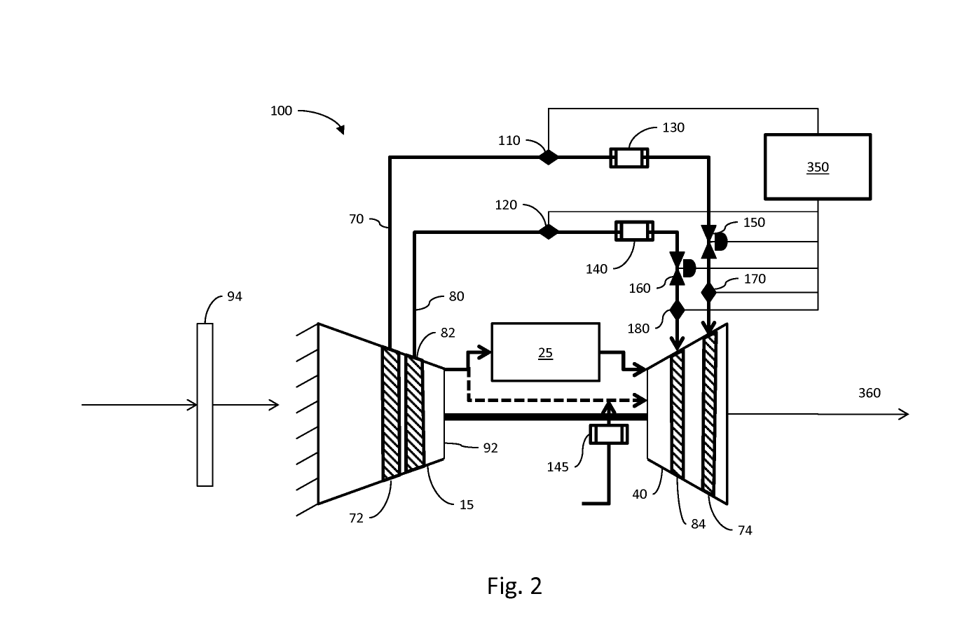

FIG. 2 shows a humid air cooling system 100 according to one embodiment. The humid air cooling system 100 may be used with the gas turbine engine 10 as described above. The humid air cooling system 100 may actively cool the components of the turbine 40 along the hot gas path therethrough, particularly about the first turbine stage 74 (which in one embodiment may be stage three of the turbine) and the second turbine stage 89 (which in one embodiment may be stage two of the turbine).

The humid air cooling system 100 may include a first flow and temperature sensor 110 positioned about the first extraction conduit 70. Likewise, the humid air cooling system 100 may include a second flow and temperature sensor 120 positioned about the second extraction conduit 80. The first flow and temperature sensor 110, and the second flow and temperature sensor 120 may be of conventional design. The first flow and temperature sensor 110, and the second flow and temperature sensor 120 thus determine the flow rate and temperature of the flow of air 20 in the first extraction conduit 70 (first flow of air), and second extraction conduit 80 (second flow of air).

The humid air cooling system 100 also may include a first water/steam injection chamber 130 positioned about the first extraction conduit 70. First water/steam injection chamber 130 may be an evaporative cooling system where distilled water is supplied to an absorptive media and exposed to the flow of air through the media for evaporating the water though the energy in the air. Alternately a plurality of manifolds and nozzles may provide a spray of finely atomized water or steam into the air flow.

Likewise, the humid air cooling system 100 may include a second water/steam injection chamber 140 positioned about the second extraction conduit 80. First water/steam injection chamber 130, and second water/steam injection chamber 140 may be in communication with any heating or cooling medium from any source. Other components and other configurations may be used herein.

Humid air cooling system 100 may include a first control valve 150 disposed on the first extraction conduit 70 downstream from the first water/steam injection chamber 130. The first control valve 150 controls the amount of humid air that is injected into the first turbine stage 74. Additionally, a first downstream sensor 170 is disposed downstream from the first water/steam injection chamber 130 and is used to determine the temperature and flow rate of the humid air flow that is injected into the first turbine stage 74. Similarly, humid air cooling system 100 may include a second control valve 160 disposed on the second extraction by 80 downstream from the second water/steam injection chamber 140. The second control valve 160 controls the amount of humid air that is injected into the second turbine stage 84. Additionally, a second downstream sensor 180 is disposed downstream from the second water/steam injection chamber 140 and is used to determine the temperature and flow rate of the humid air flow that is injected into the second turbine stage 84.

Adding humidity to the turbine nozzle cooling flows with water/steam injection improves the specific heat (Cp) of the cooling air and to a lesser extent that of the primary flow. Additionally, adding humidity to the turbine nozzle cooling flows with water/steam injection lowers stage operating temperature, improving parts life and enables active parts life management by modulating injection at each stage. Another benefit from adding humid air to the turbine nozzle cooling flows is that it increases stage mass flow thereby increasing peak output. Adding humid air also lowers exhaust gas temperature during low load operation, thereby improving ability to meet the heat recovery steam generator Isotherm limit on gas turbine uprates

The humid air cooling system 100 may be operated by a cooling controller 350. The cooling controller 350 may be in communication with the overall control system of the gas turbine engine 10 or integrated therewith. The cooling controller 350 may receive feedback from the various flow sensors so as to operate the various control valves and block valves as appropriate so as to control the temperature of the air extractions 65 as well as the temperature of the hot gas path components. Additionally, the amount of fluid to be added by the first water/steam injection chamber 130 (first amount of fluid) and the second water/steam injection chamber 140 (second amount of fluid) may be controlled by cooling controller 350.

The cooling controller 350 of the humid air cooling system 100 described herein thus monitors the flow rate and temperature within the first extraction conduit 70 and the second extraction conduit 80 as well as the temperature of the hot gas path components within the turbine 40 and the load conditions thereon. The temperature of the air extractions 65 thus may be varied via the first water/steam injection chamber 130, and the second water/steam injection chamber 140.

The cooling controller 350 also may compensate for the variable cooling flow provided by the humid air cooling system 100. An exhaust temperature sensor 360 may be positioned downstream of the turbine 40 so as to determine the exhaust gas temperature. Because the gas turbine engine 10 may be controlled to an exhaust temperature control schedule, the cooling controller 350 may receive input from the exhaust temperature sensor 360, as well as the second flow and temperature sensor 120 and the first flow and temperature sensor 110, so as to provide an adequate compensation factor for the additional cooling humid air. The cooling controller 350 thus may provide stage level time at temperature tracking and management.

The cooling controller 350 may be a standalone processor or part of a larger control system such as the General Electric SPEEDTRONIC™ Gas Turbine Control System, such as is described in Rowen, W. I., “SPEEDTRONIC™ Mark V Gas Turbine Control System”, GE-3658D, published by GE Industrial & Power Systems of Schenectady, N.Y. The cooling controller 350 may be a computer system having a processor (s) that executes programs to control the operation of the gas turbine using sensor inputs and instructions from human operators. The programs executed by the cooling controller 350 may include scheduling algorithms for regulating fuel flow to the combustor 25. The commands generated by the cooling controller 350 cause actuators on the humid air cooling system 100 to, for example, adjust the first control valve 150 and the second control valve 160.

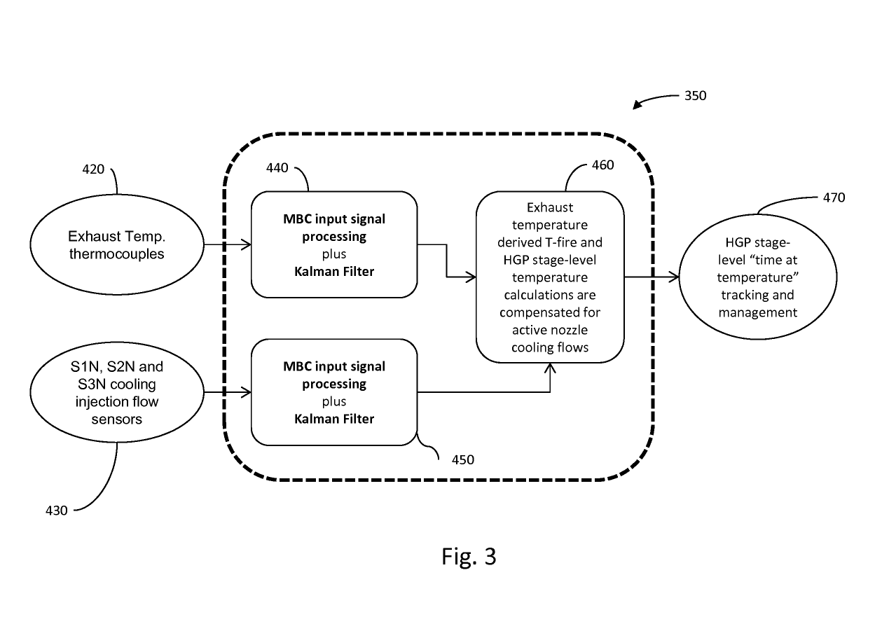

FIG. 3 is a functional schematic of an embodiment of the cooling controller 350. Exhaust temperature values 420 measured by exhaust temperature sensors may be processed by first processing module 440. First processing module 440 may be a model based control algorithm that uses a linear quadratic estimation algorithm (Kalman filter). Cooling injection flow values 430 measured by first downstream sensor 170 and second downstream sensor 180 are also provided to a second processing module 450 that may be a model based control algorithm that uses a Kalman filter. The outputs from first processing module 440 and second processing module 450 are provided to a third processing module 460 where exhaust temperature, derived firing temperature, and hot gas path stage-level temperature are calculated and are compensated for active nozzle cooling flows. Another module 470 may maintain a record of the time at temperature for the various stages for tracking and management purposes.

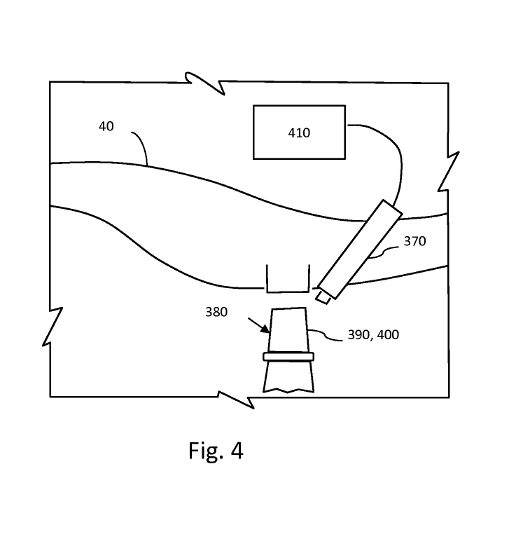

FIG. 4 shows an optical system such as an infrared camera 370 positioned about a hot gas path component 380. The hot gas path component 380 may be a blade 390, a vane 400, or other type of component positioned within the turbine 40. The infrared camera 370 may be of conventional design. The infrared camera 370 may capture a temperature distribution along the hot gas path component 380. The infrared camera 370 or other type of device may be in communication with the cooling controller 350. Diagnostic algorithms may be used to produce a condition index that reflects either the overall condition of the component surface or the condition of a specific location along the surface. Local defects, such as oxidation and spallation, may show up as aberrations about the location on the component surface. The condition index thus may be used as an indicator for the condition of the component or a portion thereof. The infrared camera 370 may include a trigger 410 for use with rotating hot gas path components. Similar types of pyrometer systems and other types of optical systems also may be used herein in a similar manner. Other components and other configurations also may be used herein.

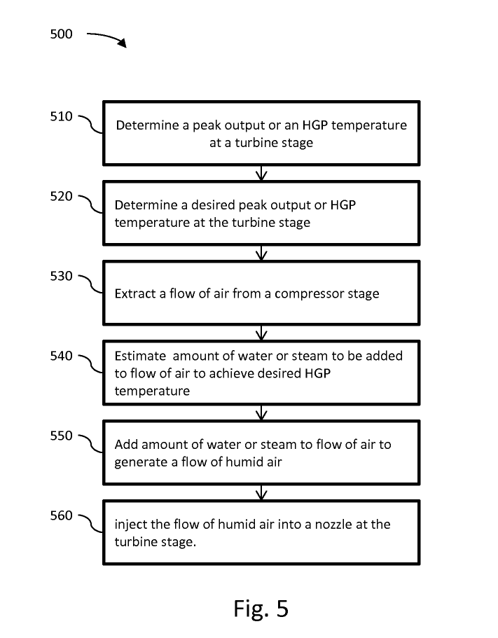

FIG. 5 shows a flowchart illustrating a method 500 for operating a gas turbine engine 10.

In step 510 the method 500 determines current state such as a desired output or a current hot gas path temperature at a turbine stage.

In step 520 the method 500 determines a desired state such as a desired output or hot gas path temperature at the turbine stage.

In step 530 the method 500 extracts a flow of air from a compressor stage.

In step 540 the method 500 estimates an amount of water or steam to be added to the flow of air to achieve a desired hot gas path temperature at the turbine stage.

In step 550 the method 500 adds the amount of water or steam to the flow of air to generate a flow of humid air.

In step 560 the method 500 injects the flow of humid air into a nozzle at the turbine stage.

The determination of the hot gas path temperature may be accomplished by measuring the hot gas path temperature with the optical transducer or measuring a combustor exhaust temperature. The determination of hot gas path temperature may be made for a plurality of turbine stages. Similar determination of a desired hot gas path temperature may be made for a plurality of turbine stages. The extraction of the flow of air may be accomplished by extracting flows of the air from a plurality of compressor stages. The estimation of the amount of water or steam to be added may include estimating the amount of water or steam to be added to each of a plurality of air flows. Similarly the addition of water or steam to the flow of air may include adding water or steam to a plurality of air flows.

The humid air cooling system 100 thus may control the temperature of the hot gas path component 380, particularly in operating conditions such as peak loads and low loads, so as to provide increased cooling as required. The humid air cooling system 100 permits selective over-cooling of the impacted components with a variable cooling flow based on the temperature compensation scheme described herein to adequately control the overall load. Moreover, selectively overcooling all of the stages of the turbine 40 may provide active component life management so as to extend overall performance of the gas turbine engine 10 beyond current boundaries for a length of time in the context of additional authority for peak over-firing.

The humid air cooling system 100 thus improves the lifetime of the hot gas path component 380 by compensating for the increased heat produced during peak operations, extended turndown operations, and other types of operational parameters. Moreover, the humid air cooling system 100 adds the ability to operate beyond normal peak loads for limited amounts of time. The humid air cooling system 100 thus may improve overall gas turbine engine lifestyle economics while providing operational flexibility in a relatively low cost system.

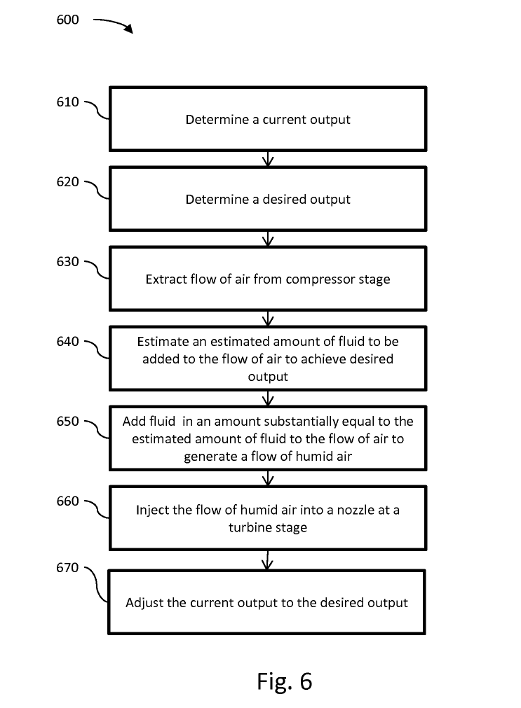

FIG. 6 is a flow chart of an embodiment of a method 600 for improving an output of a gas turbine.

In step 610, the method 600 determines a current output.

In step 615, the method 600 determines a desired output.

In step 620, the method 600 extracts a flow of air from a compressor stage.

In step 625, the method 600 estimates an estimated amount of fluid to be added to the flow of air to achieve the desired output.

In step 630, the method 600 adds a fluid in an amount substantially equal to the estimated amount of fluid to the flow of air to generate a flow of humid air.

In step 635, the method 600 injects the flow of humid air into a nozzle at a turbine stage. This may be accomplished by injecting a flow of humid air into a plurality of nozzles at a plurality of turbine stages.

In step 640, the method 600 adjusts the current output to the desired output.

Where the definition of terms departs from the commonly used meaning of the term, applicant intends to utilize the definitions provided below, unless specifically indicated.

The terminology used herein is for the purpose of describing particular embodiments only and is not intended to be limiting of the invention. Where the definition of terms departs from the commonly used meaning of the term, applicant intends to utilize the definitions provided herein, unless specifically indicated. The singular forms “a”, “an” and “the” are intended to include the plural forms as well, unless the context clearly indicates otherwise. It will be understood that, although the terms first, second, etc. may be used to describe various elements, these elements should not be limited by these terms. These terms are only used to distinguish one element from another. The term “and/or” includes any, and all, combinations of one or more of the associated listed items. The phrases “coupled to” and “coupled with” contemplates direct or indirect coupling.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements.

What is claimed:

1. A method for operating a gas turbine engine, comprising:
determining a desired state at a turbine stage;
determining a current hot gas path temperature determining a desired hot gas path temperature at the turbine stage;
extracting a flow of air from a compressor stage;
estimating an estimated amount of fluid to be added to the flow of air to achieve a desired hot gas path temperature at the turbine stage;
adding a fluid in an amount substantially equal to the estimated amount of fluid to the flow of air to generate a flow of humid air; and
injecting the flow of humid air into a nozzle at the turbine stage.

2. The method of claim 1, wherein the fluid is water or steam.

3. The method for operating a gas turbine engine of claim 1, wherein determining a current hot gas path temperature comprises measuring the current hot gas path temperature with an optical transducer.

4. The method for operating a gas turbine engine of claim 1, wherein determining a current hot gas path temperature comprises measuring a combustor exhaust temperature.

5. The method for operating a gas turbine engine of claim 1 wherein determining a current hot gas path temperature comprises determining a current hot gas path temperature at a first turbine stage and determining a current hot gas path temperature at a second turbine stage.

6. The method for operating a gas turbine engine of claim 5 wherein determining a desired hot gas path temperature at the turbine stage comprises:
determining a desired hot gas path temperature at a first turbine stage; and
determining a desired hot gas path temperature at a second turbine stage.

7. The method for operating a gas turbine engine of claim 6, wherein extracting a flow of air comprises:
extracting a first flow of air from a first compressor stage; and
extracting a second flow of air from a second compressor stage.

8. The method for operating a gas turbine engine of claim 7 wherein estimating an amount of fluid to be added to the flow of air comprises:
estimating a first amount of fluid to be added to the first flow of air; and
estimating a second amount of fluid to be added to the second flow of air.

9. A system, comprising:
a temperature sensor disposed at a turbine stage;
a subsystem for determining a desired hot gas path temperature at the turbine stage;
an extraction conduit coupled to a compressor stage adapted to extract a flow of air;
a subsystem for estimating an amount of water or steam to be added to the flow of air to achieve the desired hot gas path temperature;
a water or steam injection component adapted to inject the amount of water or steam to the flow of air to generate a flow of humid air; and
an injection subsystem adapted to inject the flow of humid air into a nozzle at the turbine stage.

10. The system of claim 9, wherein the temperature sensor is an optical transducer.

11. The system of claim 9, wherein the water or steam injection component comprises a water or steam injection chamber.

12. The system of claim 9, further comprising:
a second temperature sensor disposed at a second turbine stage;
a second extraction conduit coupled to a second compressor stage adapted to extract a second flow of air; and
a second subsystem for determining a desired hot gas path temperature at a second turbine stage;
a second subsystem for estimating a second amount of water or steam to be added to the second flow of air to achieve the desired hot gas path temperature and the second turbine stage; and
a second fuel injection component adapted to inject a second amount of water or steam to the second flow of air to generate a second flow of humid air; and
a second injection subsystem adapted to inject second flow of humid air into a nozzle at the second turbine stage.

13. A gas turbine engine, comprising:
a compressor;
a turbine;
a conduit coupled to a stage of the compressor adapted to extract a flow of air;
a temperature sensor adapted to measure a hot gas path temperature at a stage of the turbine;
a water or steam injection chamber coupled to the conduit and adapted to inject a predetermined amount of water or steam to the flow of air to generate a flow of humid air; and
an injector coupled to the conduit and adapted to inject the flow of humid air into the stage of the turbine.

14. The gas turbine engine of claim 13, wherein the temperature sensor comprises an optical transducer.

15. The gas turbine engine of claim 13 further comprising a second extraction conduit coupled to a second stage of the compressor adapted to extract a second flow of air.

16. The gas turbine engine of claim 15 further comprising a second temperature sensor adapted to measure a second hot gas path temperature at a second stage of the turbine.

17. The gas turbine engine of claim 16 further comprising:
a second water or steam injection chamber coupled to the second extraction conduit, and adapted to inject a second predetermined amount of water or steam to generate a second flow of humid air; and
a second injector coupled to the second extraction conduit and adapted to inject the second flow of humid air into the second stage of the turbine.

18. A method for improving an output of a gas turbine having a compressor and a turbine, the method comprising:
determining a current output;
determining a desired output;
extracting a flow of air from a compressor stage;
estimating an estimated amount of fluid to be added to the flow of air to achieve the desired output;
adding a fluid in an amount substantially equal to the estimated amount of fluid to the flow of air to generate a flow of humid air;
injecting the flow of humid air into a nozzle at a turbine stage; and
adjusting the current output to the desired output.

19. The method for improving the output of a gas turbine of claim 18, wherein the fluid is water or steam.

20. The method for improving the output of a gas turbine of claim 18, wherein injecting a flow of humid air into a nozzle at the turbine stage comprises injecting a flow of humid air into a plurality of nozzles at a plurality of turbine stages.
